(19) United States
(12) Patent Application Publication
(10) Pub. No.: US 2007/0129881 A1
(43) Pub. Date: Jun. 7, 2007

(54) Vehicle positioning apparatus and method

(76) Inventor: Chih-Cheng Chien, Shenkeng Township (TW)

Correspondence Address: J.C. Patents, Inc., Suite 250, 4 Venture, Irvine, CA, 92618, US

(21) Appl. No.: 11/471,243

(22) Filed: Jun. 19, 2006

(30) Foreign Application Priority Data
Dec. 6, 2005 (TW) 94142903

(51) Int. Cl. G01C 21/00

(52) U.S. Cl. 701/207; 340/988

(57) ABSTRACT

A vehicle positioning apparatus and method are provided, which includes a magnetic source, a sensing unit, a signal process unit, and a display unit. The magnetic source is installed at a parking space and generates a magnetic field. The sensing unit, the signal process unit, and the display unit are all installed in a vehicle and the signal process unit is coupled between the sensing unit and the display unit. The sensing unit is capable of sensing the magnetic field intensity of the magnetic field. The signal process unit estimates the relative distance of the vehicle to the magnetic source according to the sensed magnetic field intensity.

### CROSS-REFERENCE TO RELATED APPLICATION

This application claims the priority benefit of Taiwan application serial no. 94142903, filed on Dec. 6, 2005. All disclosure of the Taiwan application is incorporated herein by reference.

### BACKGROUND OF THE INVENTION

1. Field of Invention

The present invention relates to a vehicle positioning system, and more particularly, to an apparatus and method for positioning a vehicle with a magnetic energy sensing way.

2. Description of Related Art

A new driver experiences a biggest problem of poorly reversing a car into a garage, or of parking the car at a roadside, etc. Though a current car rear view system with a miniature camera is used to assist the new driver's viewing the rear situation and the multiple cameras are fitted to eliminate their blind sections, such an apparatus is too expensive to be used in practice. Also, the driver must estimate the relative positions and distance of the car only through the aid of an image display, which causes the driver's distraction and misjudgment of distance of the car and thus troubles the parking.

The conventional back radar or infrared sensing is mostly used in a crash avoidance system for measuring a relative distance of the car to a rear approaching vehicle or an object by using the signal reflection principle and then sending an alarm. However, in the aspect of vehicle parking positioning, no electronic apparatus can be widely used in both the vehicle and a parking positioning mark, such that the vehicle is easily pulled off to the left or to the right, or its car door could bump against a neighboring vehicle during the opening the car door when parked. Moreover, in an auto parking system, the relative position of the vehicle to the parking space is typically sensed by using multiple radars or infrared sensors, a visual system, an infrared sensor, and so on. But such a system is expensive and usually applied in large, advanced parking lots. When parking the car in a family garage or at a roadside, there is no simple positioning mark for facilitating the assistance of the driver's parking.

### SUMMARY OF THE INVENTION

An object of the present invention is to provide a vehicle positioning apparatus, which can be applied to a vehicle positioning sensing in an auto parking system, and enables a driver to acquire a relative distance of the vehicle to a parking space through a magnetic energy sensing.

Another object of the present invention is to provide a vehicle positioning method, in which the relative relationship of the vehicle to the parking space are calculated by using the magnetic field intensity, and the driver can determine the advancing direction of the vehicle when parked through the aid of a letter, graphic, or indicator.

To achieve above and other objects, the present invention provides a vehicle positioning apparatus including a magnetic source, a sensing unit, a signal process unit, and a display unit. The magnetic source is installed at a positioning point outside the vehicle. The magnetic source includes a magnetic object, which generates a magnetic field for the vehicle to sense a parking space. The other three parts are installed in the vehicle. The signal process unit is coupled between the sensing unit and the display unit. The sensing unit is used for sensing the magnetic field intensity of the magnetic field, and outputting an identification signal to the signal process unit according to the sensing result. After the signal process unit carries out a data comparison or computation, a position signal is output to the display unit, and the relative distance of the vehicle to the parking space is displayed by the display unit.

In an embodiment, the aforementioned signal process unit further includes a computation unit and a control unit, wherein the computation unit computes the relative distance of the vehicle to the positioning point in the parking space according to the identification signal and then outputs the computation result, and the control unit outputs a positioning signal according to the computation result.

From another point of view, the present invention further provides a vehicle positioning method, suitable for sensing the relative distance of the vehicle to the positioning point outside the vehicle. The method includes generating a magnetic field at a positioning point on the parking space; sensing the magnetic field intensity of the magnetic field in the vehicle, and outputting an identification signal according to the magnetic field intensity; outputting an positioning signal according to the identification signal, wherein the positioning signal indicates the relative distance of the vehicle to the positioning point; and displaying the aforementioned positioning signal.

According to the present invention, the magnetic field is implemented in a sensing system. Therefore no blind section exists, and omni-directionally sensing can be achieved. The relative distance of the vehicle to the positioning point in the parking space may be computed directly by using the physical property of the magnetic field intensity related with the distance, thereby eliminating a visual estimation error, and promoting the parking convenience. Also, the apparatus of the present invention is simple and suitable for being applied in a parking positioning system for a family garage or a roadside.

To the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

FIG. 1 is a block diagram of a vehicle positioning apparatus according to an embodiment of the present invention.

FIG. 2 is a view showing an practical application of the vehicle positioning apparatus according to the embodimen.

FIG. 3A is a view showing a display method of a strip indicator according to the embodiment.

FIG. 3B is a view showing a display method of an annular indicator according to another embodiment of the present invention.

FIG. 4 is a flow chart of a vehicle positioning method according to another embodiment of the present invention.

### DESCRIPTION OF EMBODIMENTS

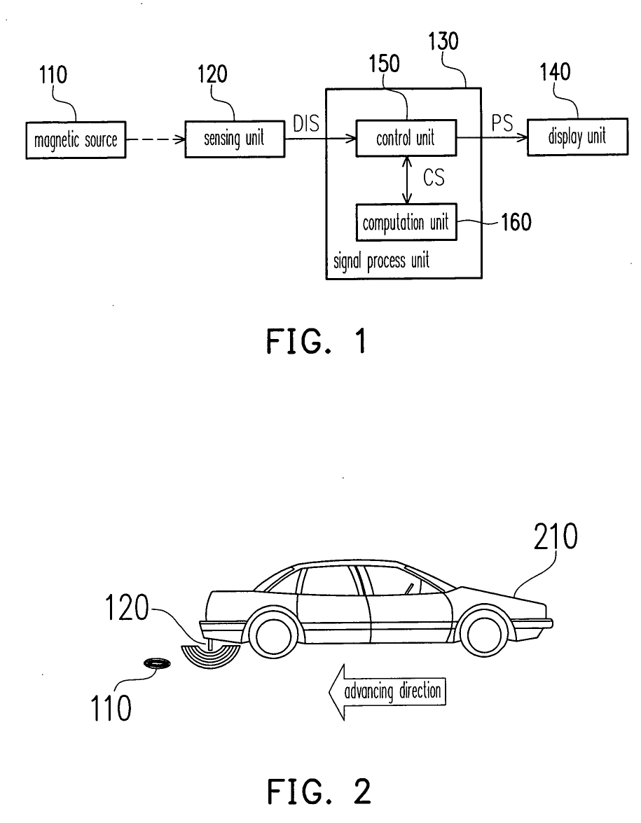

FIG. 1 is a block diagram of a vehicle positioning apparatus according to an embodiment of the present invention. The vehicle positioning apparatus includes a magnetic source 110, a sensing unit 120, a signal process unit 130, and a display unit 140. In the embodiment, the signal process unit 130 also includes a control unit 150 and a computation unit 160. The control unit 150 is coupled between the sensing unit 120 and the display unit 140, and the computation unit 160 is coupled to the control unit 150. The magnetic source 110 is installed at a positioning point outside the vehicle. Taking the application of the parking positioning guidance as an example, the positioning point is chosen to be a place where the vehicle is parked, usually at a parking space. The magnetic source 110 includes a magnetic object for providing a magnetic field. When the distance from the magnetic source 110 is far, the sensed magnetic field intensity is weak. Moreover, there is a particular physical relationship between the magnetic field intensity and the distance.

The sensing unit 120 is responsible for sensing the magnetic field intensity, and for converting a variation of the magnetic field intensity to an identification signal DIS that is then output into the control unit 150. The control unit 150 transfers the identification signal DIS to the computation unit 160, and acquires the relative distance of the vehicle to the position point through a comparison computation of the computation unit 160. The computation unit 160 outputs a computation result CS to the control unit 150 according to the relationship between relative distance and corresponding magnetic intensity. The control unit 150 outputs the positioning signal PS to the display unit 140 according to such a computation result CS. In another embodiment, the control unit 150 also can compare the relative distance of the vehicle to the position point with a comparison table, wherein the comparison table contains the data of the corresponding relationship between the magnetic field intensity and distance. The positioning signal PS indicates the relative distance of the vehicle to the positioning point. The display unit 140 displays the message indicated by the positioning signal PS in ways of at least one of letter, graphic, and indicator.

FIG. 2 is a view showing a practical application of the vehicle positioning apparatus according to the embodiment. Referring to FIGS. 1 and 2, when the positioning apparatus in the vehicle 210 is activated (for example, by pushing a reverse gear to allow the vehicle to enter a reversing state), the sensing unit 120 automatically senses the magnetic field intensity generated by the magnetic source 110, and the signal process unit 130 acquires the relative distance of the vehicle 210 to the magnetic source 110. The display unit 140 notifies the driver of the relative distance of the vehicle 210 to the magnetic source 110 through displaying or indicating alarming (or sound) in the vehicle 210.

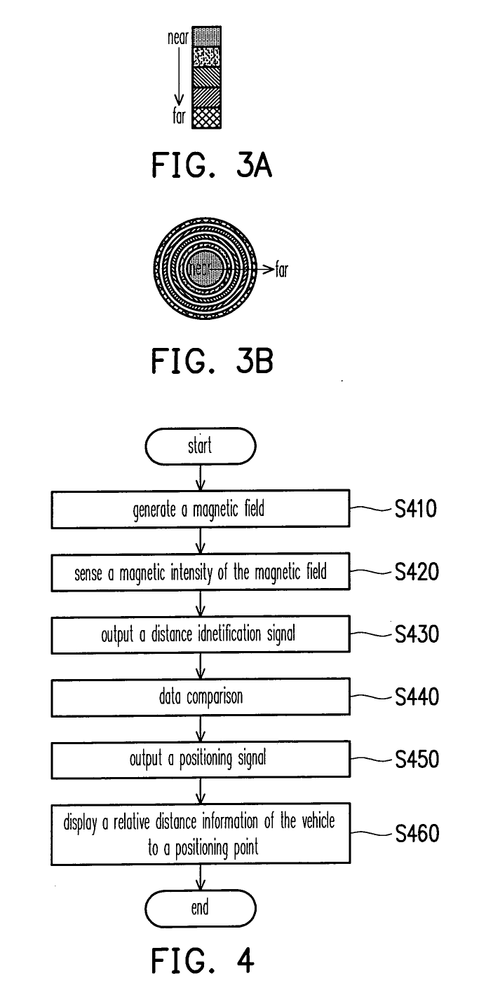

In the way of the display unit 140's displaying the positioning signal PS, display ways of the indicator includes at least one of a strip display indicator and a display annular indicator. FIG. 3A shows a strip display indicator according to this embodiment, wherein the display indicator has five colors, indicating a longer to shorter distance between the vehicle 210 and the magnetic source 110 from bottom to top. As the distance becomes shorter, the upper indicator lights accordingly inform the driver. Of course, the display indicator can also be composed of five indicators of different luminance. FIG. 3B shows another an annular display indicator according to another embodiment of the present invention, wherein the display indicator has five annular indicators, and as the distance becomes shorter, an indicator closer to the center lights accordingly inform the driver. The aforementioned display manner of a strip indicator or an annular indicator can enable the drivers to acquire the situation of current position of the vehicle 210 quickly and conveniently, and a sound alarm can also be used if desired. The number and color of the indicator assembly shown in FIGS. 3A and 3B can be adjusted according to the driver's need and is not limited to this embodiment.

The following description refers the numerals of FIGS. 1 and 2. FIG. 4 shows a vehicle positioning method according to another embodiment of the present invention, suitable for positioning the relative distance of the vehicle 210 to a positioning point outside the vehicle 210. The vehicle positioning method includes the steps as follows. In Step 410, a magnetic field is generated by the magnetic source 110 at the positioning point. Then, the vehicle is shifted into a reverse gear to start the vehicle positioning method. In Step 420, the sensing unit 120 senses the magnetic field intensity of the magnetic field in the vehicle 210. In Step 430, the sensing unit 120 outputs the identification signal DIS according to the magnetic field intensity. In Step 440, the signal process unit 130 compares the data according to the identification signal DIS, and acquires the relative distance of the vehicle 210 to the position of the position point (i.e. the magnetic source 110). In Step 450, the signal process unit 130 outputs the position signal PS for indicating the relative distance of the vehicle 210 to the position point. Eventually, in Step 460, the relative position of the vehicle 210 to the position point is displayed in the way of at least one of letter, graphic, and indicator.

In another embodiment, the comparison method in Step 440 is carried out by a data comparison between the identification signal DIS and a comparison table, such that the relative distance of the vehicle 210 to the position point can be obtained. In step S420, the magnetic field intensity of the magnetic field is sensed automatically when shifting into the reverse gear for the vehicle 210.

The present invention employs a sense method through the magnetic field intensity. Therefore, it is suitable for omni-directional sensing. Moreover, it has advantages of a simple apparatus and low cost, and it is useful for a parking positioning assistant system for a family garage or small parking lot.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A vehicle positioning apparatus, comprising:
a magnetic source, installed at a positioning point outside a vehicle, wherein the magnetic source generates a magnetic field;
a sensing unit, installed on the vehicle, for sensing the magnetic field and outputting an identification signal according to the magnetic field intensity of the magnetic field;
a signal process unit, coupled to the sensing unit and outputting a positioning signal according to the identification signal; and
a display unit, coupled to the control unit and displaying the relative distance of the vehicle to the positioning point according to the positioning signal.

2. The vehicle positioning apparatus as claimed in claim 1, wherein the magnetic source comprises a magnetic object.

3. The vehicle positioning apparatus as claimed in claim 1, wherein the signal process unit comprises a control unit coupled the sensing unit and the display unit.

4. The vehicle positioning apparatus as claimed in claim 3, wherein the signal process unit further comprises a computation unit coupled to the control unit for computing the relative distance of the vehicle to the positioning point according to the identification signal, and outputting a computation result, and the control unit outputs the positioning signal according to the computation result.

5. The vehicle positioning apparatus as claimed in claim 3, wherein the signal process unit further comprises a comparison table, and the control unit acquires the relative distance of the vehicle to the positioning point according to the identification signal and the comparison table, and outputs the positioning signal.

6. The vehicle positioning apparatus as claimed in claim 1, wherein the display unit displays the positioning signal through a way of letter, graphic or indicator.

7. The vehicle positioning apparatus as claimed in claim 1, wherein the way for the display unit to display the position signal comprises a strip indicator display.

8. The vehicle positioning apparatus as claimed in claim 1, wherein the way for the display unit to display the position signal comprises an annular indicator display.

9. A vehicle positioning method, suitable for positioning a relative distance of a vehicle to a positioning point outside the vehicle, the vehicle positioning method comprising:
generating a magnetic field at the positioning point;
sensing the magnetic field in the vehicle, outputting an identification signal according to the magnetic field intensity of the magnetic field;
outputting a positioning signal according to the identification signal; and
displaying the positioning signal.

10. The vehicle positioning method as claimed in claim 9, further comprising a step of shifting the vehicle into a reverse gear.

11. The vehicle positioning method as claimed in claim 9, wherein the step of outputting a positioning signal according to the identification signal comprises:
acquiring the relative distance of the vehicle to the positioning point according to the identification signal and a comparison table, and outputting the positioning signal.

12. The vehicle positioning method as claimed in claim 9, wherein the step of displaying the positioning signal is accomplished through a way of letter, graphic or indicator.
